(19) United States
(12) Patent Application Publication
(10) Pub. No.: US 2021/0351507 A1
(43) Pub. Date: Nov. 11, 2021

(54) 5G MM-WAVE PHASED ARRAY ANTENNA MODULE ARCHITECTURES WITH EMBEDDED TEST-CALIBRATION CIRCUITS

(71) Applicant: Mobix Labs, Inc., Irvine, CA (US)

(72) Inventor: Oleksandr Gorbachov, Irvine, CA (US)

(21) Appl. No.: 17/227,533

(22) Filed: Apr. 12, 2021

Related U.S. Application Data
(60) Provisional application No. 63/021,245, filed on May 7, 2020.

(51) Int. Cl. H01Q 3/38; H01Q 25/00; H01Q 5/45

(52) U.S. Cl. CPC H01Q 3/38; H01Q 5/45; H01Q 25/001

(57) ABSTRACT

A phased array beamformer circuit is connectible to an array of antenna elements and has one or more of radio frequency (RF) input/output ports. One or more splitter-combiners each have a combined port connected to a respective one of the one or more RF input/output ports and one or more split ports. One or more transmit/receive chains are each connected to a respective one of the split ports of the splitter-combiners and to a respective one of the antenna elements of the array. An RF calibration and test circuit has one or more calibration and test ports, each corresponding to given ones of the antenna elements of the array and are selectively connectible to the transmit/receive chain to which the given ones of the antenna elements is associated.

### CROSS-REFERENCE TO RELATED APPLICATIONS

This application relates to and claims the benefit of U.S. Provisional Application No. 63/021,245 filed May 7, 2020 and entitled “5G MM-WAVE PHASED ARRAY ANTENNA MODULE ARCHITECTURES WITH EMBEDDED TEST-CALIBRATION CIRCUITS” the disclosure of which is wholly incorporated by reference in its entirety herein.

### STATEMENT RE: FEDERALLY SPONSORED RESEARCH/DEVELOPMENT

Not Applicable

### BACKGROUND

### 1. Technical Field

The present disclosure relates generally to radio frequency (RF) communications devices, and more particularly, to phased array antenna module architectures for 5G millimeter wave applications with embedded test calibration circuits.

### 2. Related Art

Wireless communications systems find applications in numerous contexts involving information transfer over long and short distances alike, and a wide range of modalities tailored for each need have been developed. Chief among these systems with respect to popularity and deployment is the mobile or cellular phone. Generally, wireless communications utilize a radio frequency carrier signal that is modulated to represent data, and the modulation, transmission, receipt, and demodulation of the signal conform to a set of standards for coordination of the same. Many different mobile communication technologies or air interfaces exist, including GSM (Global System for Mobile Communications), EDGE (Enhanced Data rates for GSM Evolution), and UMTS (Universal Mobile Telecommunications System).

Various generations of these technologies exist and are deployed in phases, the latest being the 5G broadband cellular network system. 5G is characterized by significant improvements in data transfer speeds resulting from greater bandwidth that is possible because of higher operating frequencies compared to 4G and earlier standards. The air interfaces for 5G networks are comprised of two frequency bands, frequency range 1 (FR1), the operating frequency of which being below 6 GHz with a maximum channel bandwidth of 100 MHz, and frequency range 2 (FR2), the operating frequency of which being above 24 GHz with a channel bandwidth between 50 MHz and 400 MHz. The latter is commonly referred to as millimeter wave (mmWave) frequency range. Although the higher operating frequency bands, and mmWave/FR2 in particular, offer the highest data transfer speeds, the transmission distance of such signals may be limited. Furthermore, signals at this frequency range may be unable to penetrate solid obstacles. To overcome these limitations while accommodating more connected devices, various improvements in cell site and mobile device architectures have been developed.

One such improvement is the use of multiple antennas at both the transmission and reception ends, also referred to as MIMO (multiple input, multiple output), which is understood to increase capacity density and throughput. A series of antennas may be arranged in a single or multi-dimensional array, and further, may be employed for beamforming where radio frequency signals are shaped to point in a specified direction of the receiving device. A transmitter circuit feeds the signal to each of the antennas with the phase of the signal as radiated from each of the antennas being varied over the span of the array. The collective signal to the individual antennas may have a narrower beam width, and the direction of the transmitted beam may be adjusted based upon the constructive and destructive interferences from each antenna resulting from the phase shifts. Beamforming may be used in both transmission and reception, and the spatial reception sensitivity may likewise be adjusted. Beamforming presents a spatial selectivity as well.

In further detail, a typical 5G mm-wave beamformer architecture includes a single RF signal input port and multiple antennas. The transmit signal at the defined carrier frequency is applied to the RF signal input port. The input signal is split into multiple chains using a splitter circuit, which may be a Wilkinson-type splitter. The split portions of the RF input signal are passed to individual transmit chains that may each comprise a phase shifter, a variable gain amplifier (VGA), and a power amplifier (PA), the output of which is connected to a single antenna element.

This interface circuit between the single RF signal input port and the antenna array is configured for receive operations as well, and includes individual receive chains, some of the components of which are shared with the transmit chain. The receive chain includes a low noise amplifier (LNA) and a variable gain amplifier, with the input to the low noise amplifier being connected to a single antenna element. There is an intermediate RF switch, typically of the single pole, double throw type in which the pole terminal is connected to the antenna, the first throw terminal is connected to the transmit chain (e.g., the output of the power amplifier), and the second throw terminal is connected to the receive chain (e.g., the input of the low noise amplifier). The output of the receive chain variable gain amplifier is connected to a second RF switch, which is similarly of a single pole, double throw type in which the pole terminal is connected to the phase shifter, the first throw terminal is connected to the transmit chain (e.g., the input of the transmit chain variable gain amplifier), and the second throw terminal is connected to the receive chain (e.g., the output of the receive chain variable gain amplifier). The phase shifters are each connected to a combiner circuit, which has a single RF signal output port. Conventionally, the combiner circuit is also a Wilkinson-type. The aforementioned splitter and such combiner circuit may be a single splitter-combiner.

Various beamformer architectures may have separate or common phase shifters in the transmit and receive chains. In a typical 5G beamformer circuit for mm-wave phased array antennas, there may be up to several hundred transmit and receive chains. During the manufacturing process, each chain must be tested individually. Conventionally, direct current (DC) characteristics of a radio frequency integrated circuit (RFIC) is tested as known-good-die (KGD). Where a beamformer circuit is in a separate RFIC, it may be completely tested and calibrated in its production line by measuring RF characteristics on an evaluation board in a 50-ohm environment without factoring any mismatch between antenna elements as would otherwise exist in an actual application. This has the potential to significantly change the RF performance characteristics of the entire solution. Combining separate RFICs with the antennas require over-the-air (OTA) testing in a special chamber in an expensive and time-consuming procedure. Moreover, there are many uncertainties involved during the manufacturing and assembling process, either with the RFIC or with the antenna, or both. Presently, if the RFIC is embedded in a single package with antennas (antenna-in-package) and includes beamformers, OTA testing is understood to be the conventionally preferred solution. It is possible to separately test and preliminarily calibrate the RFIC, while the antenna package is also tested separately. However, this results in high testing costs, and some additional testing after assembling the RFIC into an antenna package may be unavoidable.

Accordingly, there is a need in the art for phased array antenna architectures in which low-cost RF test and calibration procedures are possible during production, while real antenna elements are in place, and avoid the time and expense of OTA tests. There is a need for such architectures to accommodate testing and calibration of gain, power, linearity, phase shift of both transmit and receive chains, as well as testing and calibration of the mismatch between antenna elements.

### BRIEF SUMMARY

The present disclosure contemplate improvements toward the testing and calibration of antenna-in-package phased antenna array integrated circuits, particularly those in which over-the-air testing can be eliminated. In accordance with the disclosed embodiments, the gain, power, linearity, and phase shift of both the transmit and receive chain circuitry can be tested and calibrated during production.

In one embodiment, there may be a phased array beamformer circuit that is connectible to an array of antenna elements. Such circuit may include one or more of radio frequency (RF) input/output ports. Additionally, there may be one or more of splitter-combiners, each of which may include a combined port connected to a respective one of the one or more RF input/output ports. The splitter combiner may also include one or more split ports. The circuit may further include one or more transmit/receive chains, each of which may be connected to a respective one of the split ports of the splitter-combiners and to a respective one of the antenna elements of the array. Furthermore, there may be an RF calibration and test circuit with one or more calibration and test ports. These calibration and test ports may each correspond to given ones of the antenna elements of the array and may also be selectively connectible to the transmit/receive chain to which the given ones of the antenna elements are associated.

Another embodiment may be an RF integrated circuit that is connectible to an array of antenna elements. The integrated circuit may include an RF input/output port that is specific to an operating band and an antenna polarization. There may also be a splitter-combiner that includes a combined port connected to the RF input/output port. The splitter-combiner may also include one or more combined ports. There may be one or more transmit/receive chains that are each connected to a respective one of the combined ports of the splitter-combiner. The transmit/receive chain may include a transmit segment and a receive segment. The integrated circuit may also include one or more directional couplers, each of which may be associated with a corresponding one of the transmit/receive chains. The directional couplers may include an input port that is selectively connectible to the transmit segment and the receive segment. The directional couplers may also include a transmitted port that is connected to a respective one of the antenna elements of the array. Further, the directional coupler may include a first coupled port. The integrated circuit may also include a first RF calibration and test circuit switch that selectively connects an RF calibration and test port to the first coupled port of a given one of the one or more directional couplers.

In yet another embodiment, a millimeter wave radio RF integrated circuit may include an antenna array that is defined by a plurality of cross-polarized antenna elements. Each of the antenna elements may include a horizontal feed and a vertical feed. The integrated circuit may also include one or more of RF input/output ports, as well as a plurality of array antenna interface circuits connected to a given one of the RF input/output ports. The array antenna interface circuits may also be connected to respective ones of the horizontal feed and the vertical feed of each of the cross-polarized antenna elements. There may further be an RF calibration and test circuit with calibration and test ports that correspond to each of the cross-polarized antenna elements. The calibration and test ports may be selectively connectible to the antenna array interface circuits.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is schematic diagram of a phased array beamformer circuit including a radio frequency (RF) test and calibration module in accordance with the embodiments of the present disclosure;

FIG. 2 is a schematic diagram of another embodiment of the phased array beamformer circuit in which the RF test and calibration module includes uni-directional couplers that connect transmit/receive chains to a test and calibration port;

FIG. 3 is a schematic diagram of yet another embodiment of the phase array beamformer circuit in which the RF test and calibration module includes bi-directional couplers; and

FIG. 4 is a schematic diagram of still another embodiment of the phase array beamformer circuit with the RF test and calibration module utilizing bi-directional couplers though with an alternative switching configuration.

### DETAILED DESCRIPTION

The present disclosure encompasses various embodiments of a radio frequency (RF) integrated circuit for 5G millimeter wave phased antenna array beamformer architectures incorporating a low-cost RF testing and calibration solution. The integrated circuit package may incorporate the phased antenna array therein, and testing/calibration procedures may be performed during production with real antenna elements in place. Thus, expensive and time-consuming over-the-air (OTA) testing becomes unnecessary. The embodiments of the disclosure contemplate the testing and calibration of gain, power, linearity, and phase shift in both the transmit chain and the receive chain. Additionally, mismatch of the antenna elements may be tested and calibrated.

The detailed description set forth below in connection with the appended drawings is intended as a description of the several presently contemplated embodiments of the RF integrated circuit and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

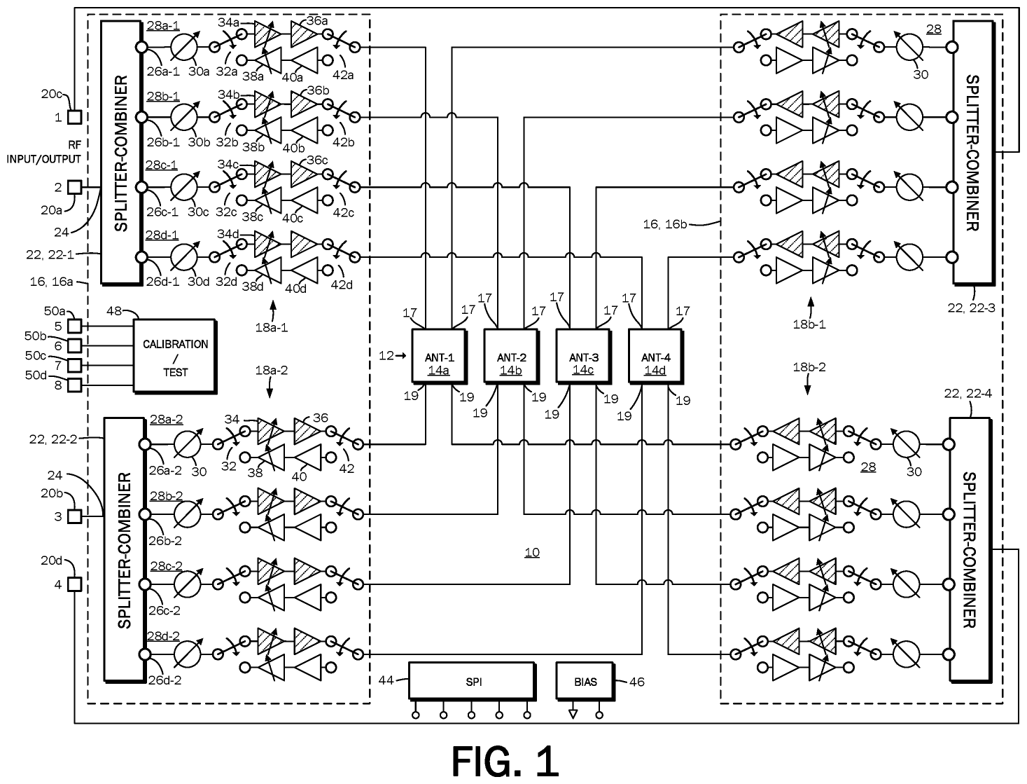

The schematic diagram of FIG. 1 illustrates an embodiment of a phased array beamformer circuit 10, which may be part of a broader RF integrated circuit including transmitters, receivers, baseband modules, and so forth. However, this is presented by way of example only, and the phased array beamformer circuit 10 may be part of an independent module separate from the RF integrated circuit.

The illustrated circuit 10 may be utilized as part of a 5G mnWave phased array antenna architecture with low band operation as well as high band operation. As understood, the 5G mobile network standard is comprised of FR1 and FR2 frequency ranges, with FR2 being commonly referred to as millimeter wave or mmWave because the operating frequency is above 24 GHz to 50 GHz. There are discrete frequency bands with defined bandwidths and may be referred to as low band or high band, e.g., 24-30 GHz as low-band and 37-44 GHz as high-band.

In the exemplary implementation, there circuit 10 may be connected to an antenna array 12 comprised of multiple antenna elements 14a, 14b, 14c, and 14d. The four antenna elements 14a-14d are presented by way of example, as there may be other implementations of a phased array antenna with additional antenna elements 14. Each of the antenna elements 14 may also be cross-polarized, that is, be vertically polarized as well as horizontally polarized. There are separate feed lines and circuit elements for each polarization, the details of which will be described more fully below.

In a phased array antenna architecture, a separate transmit signal is fed to each of the antenna elements 14 in the array 12, with some signals being phase shifted relative to another that causes constructive and destructive interference that makes beam over the air directionality possible. In this regard, a single RF transmit signal is split for the separate antenna elements 14. Likewise, the received RF signal are transduced by each of the individual antenna elements 14 and yield multiple RF receive signals, some of which may be phase shifted relative to the others. The phase shifts are then reversed and combined into a single RF output signal.

Continuing with the example of the 5G mmWave RF integrated circuit, there may be a low band array antenna interface module 16a and a high band array antenna interface module 16b. Each of the array antenna interface modules 16 may further be comprised of antenna interface circuits 18 specific to the polarization of the antenna element to which it is connected. As mentioned above, each of the antenna elements 14a-14d are cross polarized, that is, have a vertical polarization and a horizontal polarization. A first antenna interface circuit 18a-1 grouped within the low band array antenna interface module 16a is connected to a horizontal polarization feed 17 of the antenna elements 14, while a second antenna interface circuit 18a-2 also grouped within the low band array antenna interface module 16a is connected to a vertical polarization feed 19 of the antenna elements 14. Likewise, a first antenna interface circuit 18b-1 grouped within the high band array antenna interface module 16b is connected to a horizontal polarization feed 17 of the antenna elements 14, and a second antenna interface circuit 18b-2 grouped within the high band array antenna interface module 16b is connected to a vertical polarization feed 19 of the antenna elements 14.

The circuit 10 includes RF input/output ports 20 for each of the antenna interface circuits 18, including an RF input/output port 20a for the first antenna interface circuit 18a-1 of the low band array antenna interface module 16a, and another RF input/output port 20b for the second antenna interface circuit 18a-2 of the low band array antenna interface module 16a. Similarly, there is an RF input/output port 20c for the first antenna interface circuit 18b-1 of the high band array antenna interface module 16b, and another RF input/output port 20c for the second antenna interface circuit 18b-2 of the high band array antenna interface module 16b.

The first antenna interface circuit 18a-1 includes a splitter-combiner 22-1 with a combined port 24 that is connected to the RF input/output port 20a, along with multiple split ports 26-1 that are connected to corresponding transmit/receive circuits 28. Each of the transmit/receive circuits 28-1 are connected to a specific antenna element 14, and because there are four antenna elements 14a, 14b, 14c, and 14d in the illustrated example, there are four transmit/receive circuits 28a-1, 28b-1, 28c-1, and 28d-1 corresponding and connected thereto. Likewise, the splitter-combiner 22 includes four split ports 26a-1, 26b-1, 26c-1, and 26d-1 connected to the transmit/receive circuits 28a-1, 28b-1, 28c-1, and 28d-1, respectively. The splitter-combiner 22-1 is understood to be a Wilkinson-type splitter, though any other suitable splitter circuit known in the art or subsequently developed may be utilized without departing from the scope of the present disclosure.

Each of the transmit/receive circuits 28a-1, 28b-1, 28c-1, and 28d-1 are understood to include a phase shifter 30, with the first transmit/receive circuit 28a-1 including a first phase shifter 30a, the second transmit/receive circuit 28b including a second phase shifter 30b, the third transmit/receive circuit 28c including a third phase shifter 30c, and the fourth transmit/receive circuit 28d including a fourth phase shifter 30d. The phase shifters 30 are understood to be two-port devices with a first port being connected to a respective one of the split ports 26 of the splitter-combiner, and a second port being connected to further circuit elements.

In accordance with the illustrated embodiment of the present disclosure, one phase shifter 30 is utilized for both transmit signals and receive signals, so there is a modality by which the further downstream receive chain circuitry is connected during receive operations, and further upstream transmit chain circuitry is connected during transmit operations. In this regard, each of the transmit/receive circuits 28a-1 to 28d-1 further include a single pole, double throw switch 32 operated to exclusively connect either the transmit chain circuitry or the receive chain circuitry. The second port of the first phase shifter 30a is connected to a pole terminal of a first single pole, double throw switch 32a, the second port of the second phase shifter 30b is connected to a pole terminal of a second single pole, double throw switch 32b, the second port of the third phase shifter 30c is connected to a pole terminal of a third single pole, double throw switch 32c, and a second port of the fourth phase shifter 30d is connected to a pole terminal of a fourth single pole, double throw switch 32d. Because the foregoing single pole, double throw switches 32a-32d are connected to the phase shifters 30, they will be referred to as phase shifter-side single pole, double throw switches. Furthermore, each of the throw terminals of the single pole, double throw switches 32 are connected to either of the downstream receive chain circuitry or the upstream transmit chain circuitry.

In one embodiment, the upstream transmit chain circuitry is comprised of a variable gain power amplifier 34, which in turn is connected in series with a power amplifier 36. Accordingly, the transmit chain circuitry may also be referred to as a transmission amplification segment. A first one of the throw terminals of the first phase shifter-side single pole, double throw switch 32a is connected to an input of a first variable gain power amplifier 34a, while a first one of the throw terminals of the second phase shifter-side single pole, double throw switch 32b is connected to an input of a second variable gain power amplifier 34b. Similarly, a first one of the throw terminals of the third phase shifter-side single pole, double throw switch 32c is connected to an input of a third variable gain power amplifier 34c, and a first one of the throw terminals of the fourth phase shifter-side single pole, double throw switch 32d is connected to an input of a fourth variable gain power amplifier 34d.

The downstream receive chain circuitry may be comprised of a low noise amplifier 40, which in turn is connected in series with a variable gain low noise amplifier 38. Accordingly, the receive chain circuitry may also be referred to as a reception amplification segment. A second one of the throw terminals of the first phase shifter-side single pole, double throw switch 32a is connected to an output of a first variable gain low noise amplifier 38a, while a second one of the throw terminals of the second phase shifter-side single pole, double throw switch 32b is connected to an output of a second variable gain low noise amplifier 38b. Similarly, a second one of the throw terminals of the third phase shifter-side single pole, double throw switch 32c is connected to an output of a third variable gain low noise amplifier 38c, and a second one of the throw terminals of the fourth phase shifter-side single pole, double throw switch 32d is connected to an output of a fourth variable gain low noise amplifier 38d.

The output of the transmit chain circuitry, that is, the output of the power amplifier 36, and the input to the receive chain circuitry, that is, the input of the low noise amplifier 40, are selectively connected to respective antenna elements 14. Thus, there may be a first antenna-side single pole, double throw switch 42a with a pole terminal that is connected to the first antenna element 14a, along with a first throw terminal connected to the output of a first power amplifier 36a that is part of the transmit chain circuitry including the first variable gain power amplifier 34a. The second throw terminal of the first antenna-side single pole, double throw switch 42a is connected to the input of a first low noise amplifier 40a that is part of the receive chain including the first variable gain low noise amplifier 38a. Likewise, there may be a second antenna-side single pole, double throw switch 42b with a pole terminal connected to the second antenna element 14b, a first throw terminal connected to the output of a second power amplifier 36b that is part of the transmit chain circuitry including the second variable gain power amplifier 34b, and a second throw terminal connected to the input of a second low noise amplifier 40b that is in series with the second variable gain low noise amplifier 38b. There may also be a third antenna-side single pole, double throw switch 42c with a pole terminal connected to the third antenna element 14c, a first throw terminal connected to the output of a third power amplifier 36c that is part of the transmit chain circuitry including the third variable gain power amplifier 34c, and a second throw terminal connected to the input of a third low noise amplifier 40c that is part of a receive chain including the aforementioned third variable gain low noise amplifier 38c. Lastly, there may be a fourth antenna-side single pole, double throw switch 42d with a pole terminal connected to the fourth antenna element 14d, a first throw terminal connected to the output of a fourth power amplifier 36d, and a second throw terminal connected to the input of a fourth low noise amplifier 40d that is part of a receive chain including the fourth variable gain low noise amplifier 38d.

The antenna-side single pole, double throw switches 42 and the phase shifter-side single pole, double throw switches 32 are concurrently switched in coordination with each other, so that either the circuit corresponding to the transmit chains or the receive chains is completed between phase shifter 30 and the antenna element 14. The architecture of the transmit/receive circuits 28, including the use of the splitter-combiner 22, the phase shifters 30, and so forth constitutes one implementation, and any other suitable architecture may be substituted without departing from the scope of the present disclosure.

The low band array antenna interface module 16a also includes the second antenna interface circuit 18a-2, which is comprised of similarly configured splitter-combiner 22-2 with the combined port 24 that is connected to the second RF input/output port 20b and the split ports 26-2 that are connected to the transmit/receive circuits 28. The second antenna interface circuit 18a-2 is understood to be identical to the first antenna interface circuit 18a-1, though connected to the low band feed of each of the antenna elements 14. The antenna elements connected to the first antenna interface circuit 18a-1 are understood to have a different polarization from the second antenna interface circuit 18a-2. Specifically, the first split port 26a-2 is connected to a first transmit/receive circuit 28a-2, the second split port 26b-2 is connected to a second transmit/receive circuit 28b-2, the third split port 26c-2 is connected to a third transmit/receive circuit 28c-2, and the fourth split port 26d-2 is connected to a fourth transmit/receive circuit 28d-2. Each of the transmit/receive circuits 28-2 are similarly configured as the transmit/receive circuits 28-1 of the first antenna interface circuit 18a-1, including the identical/replicated phase shifter 30, the phase shifter-side single pole, double throw switch 32, the variable gain power amplifier 34, the power amplifier 36, the variable gain low noise amplifier 38, the low noise amplifier 40, and the antenna-side single pole, double throw switch 42. Accordingly, additional details thereof will be omitted for the sake of brevity.

The phased array beamformer circuit 10 also includes the high band array antenna interface module 16b, which is comprised of two separate antenna interface circuits 18b-1 and 18b-2, which are connected to the horizontal polarization feeds 17 and the vertical polarization feeds 19 of the antenna elements 14. The third RF input/output port 20c is connected to the second antenna interface circuit 18b-1, and the fourth RF input/output port 20d is connected to the second antenna interface circuit 18b-2, but otherwise have the same configuration as the antenna interface circuits 18a-1 and 18a-2 of the low band array antenna interface module 16a. Thus, additional details thereof will not be repeated. Generally, however, a similar Wilkinson-type splitter-combiner 22 may be utilized with a set of phase shifters 30 selectively connecting the transmit/receive circuits 28 to the antenna elements 14. To the extent the operating frequencies are different, the Wilkinson-type splitter-combiners may also have a different configuration.

The phased array beamformer circuit 10 may additionally incorporate a serial peripheral interface (SPI) block 44 that may be used to connect to other integrated circuits with a corresponding SPI block. Those having ordinary skill in the art will recognize the various pinouts that are utilized, including serial clock (SCLK), master out slave in (MOSI), master in slave out (MISO), and slave select (SS) lines. Additionally, the various active components of the phased array beamformer circuit 10 are biased/powered via a bias block 46.

According to various embodiments of the present disclosure, the phased array beamformer circuit 10 further incorporates an RF calibration and test circuit 48 that allows for testing and calibration of the gain, power, linearity, and phase shift of the entire transmit and receive chains while connected to the antenna elements 14 without needing to utilize an over-the-air test. Additionally, mismatches between the antenna elements 14a-14d may be tested and calibrated. The RF calibration and test circuit 48 may also be utilized for closed-loop transmit power control in a real application. Because testing and calibration of the transmit and receive chains of a complete antenna module in an evaluation board environment is possible, testing time and costs can be substantially reduced.

The RF calibration and test circuit 48 may include a calibration and test port 50 for each of the antenna elements 14, including a first calibration and test port 50a for the first antenna element 14a, a second calibration and test port 50b for a second antenna element 14b, a third antenna calibration and test port 50c for a third antenna element 14c, and a fourth calibration and test port 50d for a fourth antenna element 14d. The calibration and test ports 50 are understood to be selectively connectible to the corresponding antenna elements 14, as will be described in further detail below. The specific number of calibration and test ports 50 may be varied in accordance with different architecture configurations, including different numbers of transmit and receive chains, number of antenna elements, and so forth.

The illustrated embodiment is configured as an antenna-in-package module, so the calibration and test ports 50 may be routed to antenna package pins. However, this is by way of example only and not of limitation. Phased array beamformer architectures with the antenna array separate from the RF integrated circuit may also be implemented with the RF calibration and test circuit 48 of the present disclosure, and similarly used for testing and calibration without OTA testing.

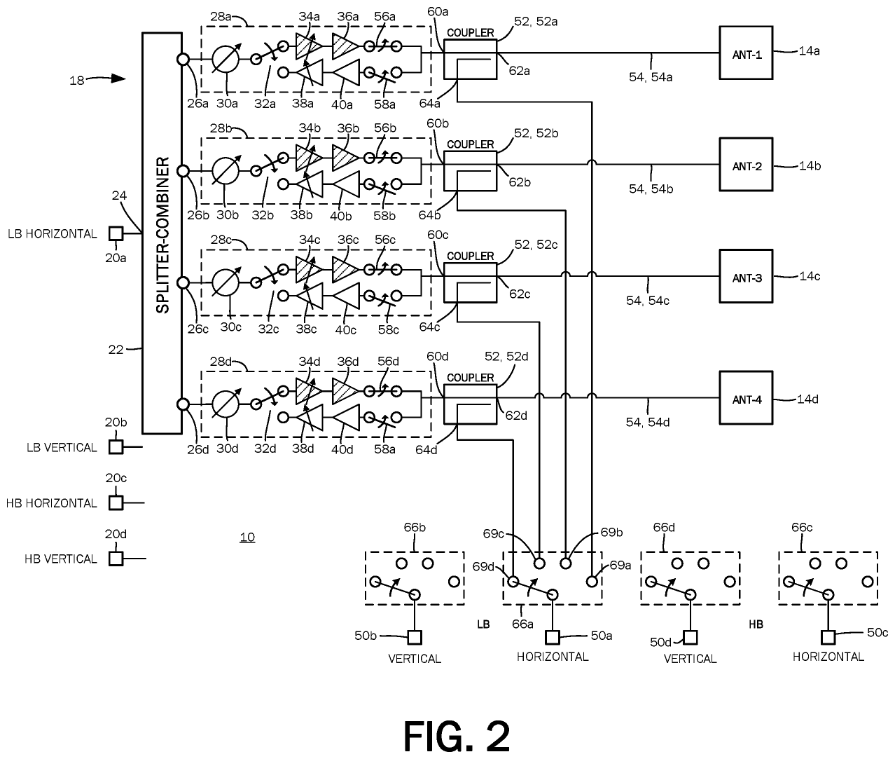

With reference to the schematic diagram of FIG. 2, in accordance with one embodiment of the present disclosure, the RF calibration and testing circuit may be based in part upon the addition of a set of directional couplers 52 into the transmit and receive circuitry, in close proximity to antenna feeds 54 to each of the antenna elements 14a-14d. The diagram illustrates an exemplary antenna interface circuit 18, which includes the first RF input/output port 20a that is connected to the combined port 24 of the splitter-combiner 22. The RF input/output port 20a is understood to be specific to an operating band (5G mmWave low band or high band), and an antenna polarization (vertical or horizontal polarization).

The split ports 26 of the splitter-combiner 22 are each connected to the separate transmit/receive circuits 28. Specifically, the split port 26a is connected to the first transmit/receive circuit 28a, the split port 26b is connected to the second transmit/receive circuit 28b, the split port 26c is connected to the third transmit/receive circuit 28c, and the split port 26d is connected to the fourth transmit/receive circuit 28d. Each of the transmit/receive circuits 28 includes the phase shifter 30, including the first phase shifter 30a, the second phase shifter 30b, the third phase shifter 30c, and the fourth phase shifter 30d.

Each transmit/receive circuit 28 has a separate transmit chain or segment and a receive chain or segment that are selectively connected to the phase shifter 30 with the single pole, double throw switch 32. The transmit chain of the first transmit/receive circuit 28a is defined by the first variable gain power amplifier 34a and the first power amplifier 36a, with the input to the first variable gain power amplifier 34a being connected to the first throw terminal of the first single pole, double throw switch 32a. The receive chain of the first transmit/receive circuit 28a is defined by the first variable gain low noise amplifier 38a and the low noise amplifier 40a, with an output of the first variable gain low noise amplifier 38a being connected to the second throw terminal of the first single pole, double throw switch 32a. The output of the first power amplifier 36a is connected to a pole terminal of a transmit single pole, single throw switch 56a, while the input to the first low noise amplifier 40a is connected to a pole terminal of a receive single pole, single throw switch 58a.

These single pole, single throw switches selectively connect the first transmit/receive circuit 28a, and specifically the transmit or receive chains thereof, to a first directional coupler 52a. In this regard, the throw terminal of the first transmit single pole, single throw switch 56a and the throw terminal of the first receive single pole, single throw switch 58a are both connected to an input port 60a of the first directional coupler 52a. A transmitted port 62a of the first directional coupler 52a is connected to the first antenna element 14a. The transmitted port 62a is understood to be the same as the receive port upon switching the transmit chain to receive chain operation.

The first directional coupler 52a also includes a coupled port 64a to which a proportion of the power/signal passing between the input port 60a and the transmitted port 62a (and vice versa) is split. In a typical embodiment, the directional coupler is fabricated from passive components, which is why the transmit/receive operations can be reversed with the same coupling factor. The coupled RF signal is then passed to an RF calibration and test circuit switch 66a, which may be a single pole, multiple throw switch. The switch in the exemplary embodiment of FIG. 2 is a single pole, quad throw (SP4T) switch. The RF calibration and test circuit switch 66a is specific to the horizontally polarized antenna feeds 54 for the 5G mmWave low band circuit. The pole terminal of the RF calibration and test circuit switch 66a is connected to the corresponding calibration and test port 50a, with the coupled port 64a of the first directional coupler 52a being connected to a first throw terminal 69a of the RF calibration and test circuit switch 66a. It is understood that in all architectures of the present disclosure, single pole single throw switches at the antenna side, e.g., the single pole, single throw switches 56, 68 may be substituted with a single SP2T (single pole, dual throw) switch.

The transmit chain of the second transmit/receive circuit 28b is defined by the second variable gain power amplifier 34b and the second power amplifier 36b, with the input to the second variable gain power amplifier 34b being connected to the first throw terminal of the second single pole, double throw switch 32b. The receive chain of the second transmit/receive circuit 28b is defined by the second variable gain low noise amplifier 38b and the second low noise amplifier 40b, with an output of the second variable gain low noise amplifier 38b being connected to the second throw terminal of the second single pole, double throw switch 32b. The output of the second power amplifier 36b is connected to a pole terminal of a transmit single pole, single throw switch 56b, while the input to the second low noise amplifier 40b is connected to a pole terminal of a receive single pole, single throw switch 58b. These single pole, single throw switches selectively connect the second transmit/receive circuit 28b, and specifically the transmit or receive chains thereof, to a second directional coupler 52b. The throw terminal of the second transmit single pole, single throw switch 56b and the throw terminal of the second receive single pole, single throw switch 58b are both connected to an input port 60b of the second directional coupler 52b. A transmitted port 62b of the second directional coupler 52b is connected to the second antenna element 14b. The second directional coupler 52b also includes a coupled port 64b that is connected to the RF calibration and test circuit switch 66a, and specifically a second throw terminal 69b thereof.

The transmit chain of the third transmit/receive circuit 28c is defined by the third variable gain power amplifier 34c and the third power amplifier 36c, with the input to the third variable gain power amplifier 34c being connected to the first throw terminal of the third single pole, double throw switch 32c. The receive chain of the third transmit/receive circuit 28c is defined by the third variable gain low noise amplifier 38c and the third low noise amplifier 40c, with an output of the third variable gain low noise amplifier 38c being connected to the second throw terminal of the third single pole, double throw switch 32c. The output of the third power amplifier 36c is connected to a pole terminal of a transmit single pole, single throw switch 56c, while the input to the third low noise amplifier 40c is connected to a pole terminal of a receive single pole, single throw switch 58c. These single pole, single throw switches selectively connect the third transmit/receive circuit 28c, and specifically the transmit or receive chains thereof, to a third directional coupler 52c. The throw terminal of the third transmit single pole, single throw switch 56c and the throw terminal of the third receive single pole, single throw switch 58c are both connected to an input port 60c of the third directional coupler 52c. A transmitted port 62c of the third directional coupler 52c is connected to the third antenna element 14c. The third directional coupler 52c also includes a coupled port 64c that is connected to the first RF calibration and test circuit switch 66a, and specifically a third throw terminal 69c thereof.

The transmit chain of the fourth transmit/receive circuit 28d is defined by the fourth variable gain power amplifier 34d and the fourth power amplifier 36d, with the input to the fourth variable gain power amplifier 34d being connected to the first throw terminal of the fourth single pole, double throw switch 32d. The receive chain of the fourth transmit/receive circuit 28d is defined by the fourth variable gain low noise amplifier 38d and the fourth low noise amplifier 40d, with an output of the fourth variable gain low noise amplifier 38d being connected to the second throw terminal of the fourth single pole, double throw switch 32d. The output of the fourth power amplifier 36d is connected to a pole terminal of a transmit single pole, single throw switch 56d, while the input to the fourth low noise amplifier 40d is connected to a pole terminal of a receive single pole, single throw switch 58d. These single pole, single throw switches selectively connect the fourth transmit/receive circuit 28d, and specifically the transmit or receive chains thereof, to a fourth directional coupler 52d. The throw terminal of the fourth transmit single pole, single throw switch 56d and the throw terminal of the fourth receive single pole, single throw switch 58d are both connected to an input port 60d of the fourth directional coupler 52d. A transmitted port 62d of the fourth directional coupler 52d is connected to the fourth antenna element 14d. The fourth directional coupler 52d also includes a coupled port 64d that is connected to the first RF calibration and test circuit switch 66a, and specifically a fourth throw terminal 69d thereof.

The RF calibration and test circuit switch 66a is understood to connect the calibration and test port 50a to each of the directional couplers 52a-d, and thus the transmit/receive circuits 28 of the antenna interface circuit 18. Therefore, the number of throw terminals corresponds to the number of directional couplers 52, as well as to the number of antenna elements 14. In the illustrated example, the RF calibration and test circuit switch 66a is therefore a single pole, quad-throw (SP4T) switch.

Similar to the circuit shown in the schematic diagram of FIG. 1, the embodiment of the phased array beamformer circuit 10 shown in FIG. 2 is understood to include each of the foregoing components of the antenna interface circuits 18 for the 5G mmWave low band, vertical polarization feed, the high band, horizontal polarization feed, and the high band, vertical polarization feed. In this regard, the schematic diagram shows the second RF input/output port 20b for the low band vertical polarization feed, the third RF input/output port 20c for the high band horizontal polarization feed, and the fourth RF input/output port 20d for the high band vertical polarization feed, though without the additional details of the respective antenna interface circuits 18 because they have been omitted for the sake of brevity. Along these lines, the circuit 10 is understood to include an RF calibration and test circuit switch 66b for the low band vertical polarization feed, an RF calibration and test circuit switch 66c for the high band horizontal polarization feed, and an RF calibration and test circuit switch 66d for the high band vertical polarization feed, each of which are understood to be connected to respective directional couplers 52.

In the embodiment shown in FIG. 2, the directional couplers 52 are understood to be uni-directional. According to a preferred, though optional embodiment, the directional coupler may have a high coupling coefficient that is greater than approximately 20 dB to 30 dB, with an associated small insertion loss of lower than approximate 0.1 dB to 0.3 dB.

When operating in a transmit mode, the transmit RF test signal is applied to the first RF input/output port 20a and split into the multiple transmit/receive circuits 28a-28d and the phase of each split signal is shifted as proscribed. The phase shifter-side single pole, double throw switches 32 is actuated to connect the pole terminals to the first throw terminals that are tied to the variable gain power amplifiers 34, where the split signal is amplified. These amplified signals are further amplified by the power amplifier 36. The transmit single pole, single throw switch is actuated to connect the outputs of the power amplifiers 36 to the input ports 60 of the directional coupler. The transmit signal is passed to the transmitted ports 62, and to the respective antenna elements 14, where it is radiated. Again, a portion of the signal passing between the input ports 60 and the transmitted ports 62 of the directional couplers 52 is passed to the coupled ports 64 and the RF calibration and test circuit switch 66. The coupled signal is understood to be proportional to the signal that is transmitted to the antenna elements 14.

The RF calibration and test circuit switch 66a can be set to connect the coupled ports 64 of any one of the directional couplers 52 to the first calibration and test port 50a. With test equipment connected to the first calibration and test port 50a, each of the entirety of transmit chains of the transmit/receive circuit 28 may be tested or calibrated for gain, phase shift, power, and linearity of the transmitting RF signal without the use of on-the-air test chambers while real antenna elements 14a-14d are used. Any mismatch between the antenna elements 14 are not introduced into the testing or calibration of the individual transmit chains, either during production or during use. Instead of utilizing the calibration and test ports 50, the transmit RF test signal may be converted to a DC voltage, though in such an embodiment, only gain and power level values may be tested without an OTA chamber.

The receive chains of each of the transmit/receive circuits 28 may also be individually tested and calibrated. Test equipment may be connected to the first calibration and test port 50a, with an RF test signal applied thereto. The RF calibration and test circuit switch 66a is set such that the terminal/first calibration and test port 50a is connected to the directional coupler for the desired transmit/receive circuit 28. The RF test signal that is applied to the coupled port 64 is passed to the input port 60, and to the receive chain of the transmit/receive circuits 28. The transmit single pole, single throw switches 56 are set to the disconnect the output of the power amplifiers 36 from the directional couplers 52, while connecting the same to the input of the low noise amplifiers 40. The RF test signal is amplified by the selected low noise amplifier 40, amplified further by the variable gain low noise amplifiers 38 to which it is connected in series, and to the single pole, double throw switch 32. This single pole, double throw switch 32 is set to connect the output from the low noise amplifier 40 to the phase shifter 30, which is connected to the splitter-combiner 22. The RF test signal is then output from the first RF input/output port 20a.

When in the reception mode, the actual antenna elements 14 remain connected to the inputs of the low noise amplifiers 40, and so any antenna mismatches are also present. Accordingly, the receive gain, phase shift, and linearity of the signal across the entirety of the receive chains of the transmit/receive circuit 28 may be tested without OTA testing during production.

Because the directional couplers 52 are contemplated to have a high coupling coefficient with small insertion loss, the performance degradation in either transmit or receive mode operation is minimized. Furthermore, the RF test signals remain sufficiently high to be useful for testing during production. Beyond testing the transmit and receive chains separately, it is also envisioned that coupling between the transmit and receive chains are possible while the antenna elements 14 are present, but without the need for an OTA test chamber.

The foregoing configuration of the RF calibration and test circuit switch 66 is presented by way of example and not of limitation. Different switch configurations and associated connections thereto may be utilized instead of the SP4T shown in the exemplary embodiment to the extent different transmit and receive chains are used in the phased array beamformer circuit 10. It is also possible for different switch configurations to be driven by the number of available pins in the integrated circuit package for the calibration and test ports 50. The RF calibration and test circuit switches 66 may also be modified to accommodate different test procedures, such as passing the RF test signal at different frequencies or polarizations, or to multiple antenna elements 14 to the same calibration and test port 50, and so on. Such modifications are deemed to be within the purview of one having ordinary skill in the art, and therefore are in the scope of the present disclosure.

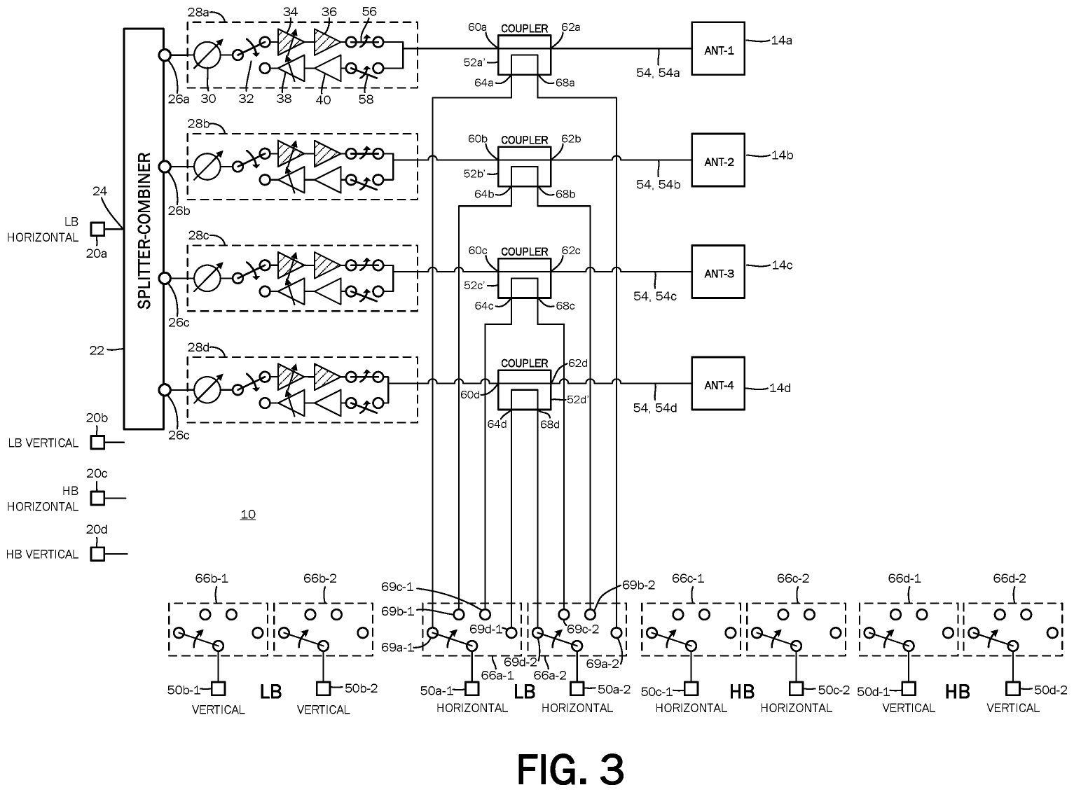

The schematic diagram of FIG. 3 illustrates another embodiment of the present disclosure in which the directional couplers 52 that are a part of the RF calibration and testing circuit are bi-directional rather than un-directional as was the case in the embodiment shown in FIG. 2. The antenna interface circuit 18 is otherwise the same and includes the first RF input/output port 20a connected to the combined port 24 of the splitter-combiner 22. The split ports 26 of the splitter-combiner 22 are each connected to the separate transmit/receive circuits 28. Specifically, the split port 26a is connected to the first transmit/receive circuit 28a, the split port 26b is connected to the second transmit/receive circuit 28b, the split port 26c is connected to the third transmit/receive circuit 28c, and the split port 26d is connected to the fourth transmit/receive circuit 28d.

Each transmit/receive circuit 28 has a separate transmit chain and a receive chain that are selectively connected to the phase shifter 30 with the single pole, double throw switch 32. The transmit chains of each transmit/receive circuit 28 includes the variable gain power amplifier 34 and the power amplifier 36, and while the receive chains each includes the variable gain low noise amplifier 38 and the low noise amplifier 40. The transmit chain and the receive chains are independently and selectively connectible to the directional coupler 52 via the separate single pole, single throw switches 56, 58. As the details of the transmit/receive circuits 28 have been discussed above, for the sake of brevity, those details will not be repeated.

The bi-directional couplers utilized in the embodiment shown in FIG. 3 each include the input port 60 and the transmitted port 62. Additionally, there is a first coupled port 64 and a second coupled port 68. The input ports 60 are connected to the transmit/receive circuits 28, and the transmitted ports 62 are connected to the antenna elements 14. In further detail, the first transmit/receive circuit 28a is connected to the input port 60a of the first bi-directional coupler 52a′, with its transmitted port 62a being connected to the first antenna element 14a. Likewise, the second transmit/receive circuit 28b is connected to the input port 60b of the second bi-directional coupler 52b′, with its transmitted port 62b being connected to the second antenna element 14b. The third transmit/receive circuit 28c is connected to the input port 60c of the third bi-directional coupler 52c′, with its transmitted port 62c connected to the third antenna element 14c. Lastly, the fourth transmit/receive circuit 28d is connected to the input port 60d of the fourth bi-directional coupler 52d′, and the transmitted port 62d thereof is connected to the fourth antenna element 14d.

Each of the first coupled ports 64 of the directional couplers 52 are connected to the RF calibration and test circuit switch 66. However, with the addition of the second coupled port 68 for each of the directional couplers 52, this embodiment may include an additional RF calibration and test circuit switch. Specifically, each of the first coupled ports 64a-64d are connected to a first RF calibration and test circuit switch 66a-1, while each of the second coupled ports 68a-68d are connected to a second RF calibration and test circuit switch 66a-2. In the illustrated example, both of the RF calibration and test circuit switches 66a-1, 66a-2 are understood to be designated for the 5G mmWave low band operation with horizontal polarization.

The first RF calibration and test circuit switch 66a-1 connects the calibration and test port 50a-1 to each of the first coupled ports 64a-64d of the directional couplers 52, and the second RF calibration and test circuit switch 66a-2 connects the calibration and test port 50a-2 to each of the second coupled ports 68a-68d of the directional couplers 52. Specifically, the first RF calibration and test circuit switch 66a-1 includes a first throw terminal 69a-1 connected to the first coupled port 64a of the first directional coupler 52a, a second throw terminal 69b-1 connected to the first coupled port 64b of the second directional coupler 52b, a third throw terminal 69c-1 connected to the first coupled port 64c of the third directional coupler 52c, and a fourth throw terminal 69d-1 connected to the first coupled port 64d of the fourth directional coupler 52d. Along the same lines, the second RF calibration and test circuit switch 66a-2 includes a first throw terminal 69a-2 connected to the second coupled port 68a of the first directional coupler 52a, a second throw terminal 69b-2 connected to the second coupled port 68b of the second directional coupler 52b, a third throw terminal 69c-2 connected to the second coupled port 68c of the third directional coupler 52c, and a fourth throw terminal 69d-2 connected to the second coupled port 68d of the fourth directional coupler 52d. The number of throw terminals of both the first and second RF calibration and test circuit switches 66a-1, 66a-2 correspond to the number of directional couplers 52, as well as to the number of antenna elements 14. In the illustrated example, the RF calibration and test circuit switches 66a-1, 66a-2 are thus a single pole, quad-throw (SP4T) switch.

The embodiment of the phased array beamformer circuit 10 shown in FIG. 3 is understood to include each of the foregoing components of the antenna interface circuits 18 for the 5G mmWave low band, vertical polarization feed, the high band, horizontal polarization feed, and the high band, vertical polarization feed. The schematic diagram shows the second RF input/output port 20b for the low band vertical polarization feed, the third RF input/output port 20c for the high band horizontal polarization feed, and the fourth RF input/output port 20d for the high band vertical polarization feed, though without the additional details of the respective antenna interface circuits 18 because they have been omitted for the sake of brevity. Along these lines, the circuit 10 is understood to include first and second RF calibration and test circuit switches 66b-1 and 66b-2 for the low band vertical polarization feed, first and second RF calibration and test circuit switches 66c-1 and 66c-2 for the high band horizontal polarization feed, and first and second RF calibration and test circuit switches 66d-1 and 66d-2 for the high band vertical polarization feed, each of which are understood to be connected to respective directional couplers 52.

The embodiment of the phased array beamformer circuit 10 shown in FIG. 3 is envisioned to have the same capability of testing the entirety of the transmit and receive chains of each of the transmit/receive circuits for gain, phase shift, power, and linearity without the need for OTA test chambers while real antenna elements 14 are in place. Additionally, however, this embodiment contemplates the measurement of real-time antenna mismatch characteristics in both the transmit mode and the receive mode during production, or in the transmit mode in an actual use setting. More specifically, in transmit and receive mode the direct path signal as well as reflected path signal may be tested.

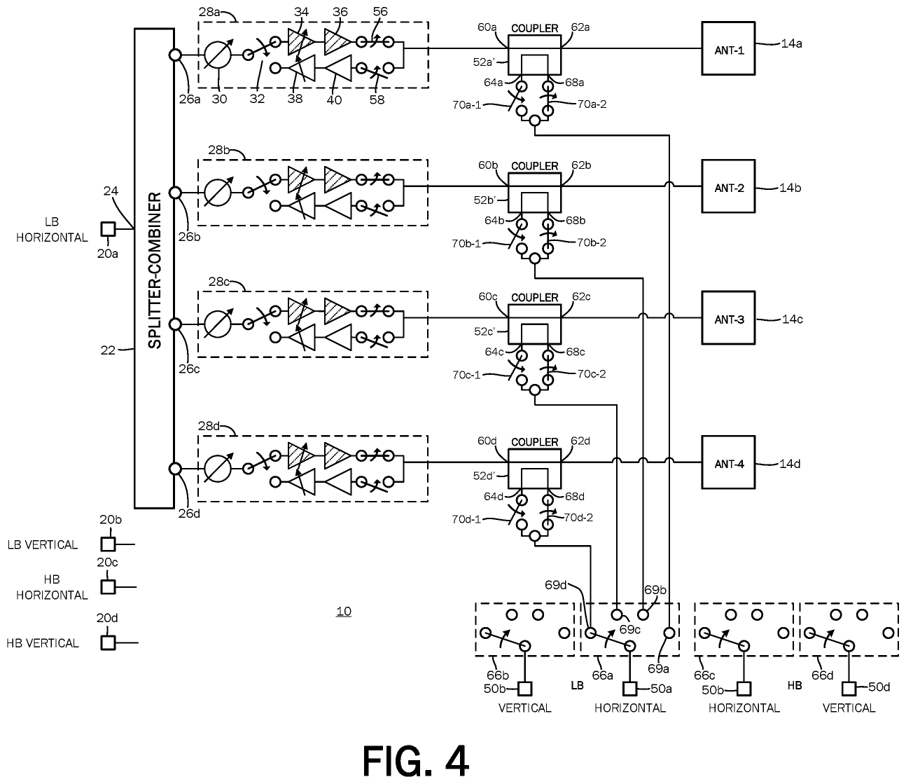

The schematic diagram of FIG. 4 illustrates still another embodiment of the present disclosure that utilizes the same RF calibration and testing circuit including the bi-directional couplers 52′ as in the embodiment shown in FIG. 3, though with an alternative configuration by which the number of the RF calibration and test circuit switches 66 may be reduced. The antenna interface circuits 18 are also the same and includes the first RF input/output port 20a connected to the combined port 24 of the splitter-combiner 22. The split ports 26 of the splitter-combiner 22 are each connected to the separate transmit/receive circuits 28, with the split port 26a being connected to the first transmit/receive circuit 28a, the split port 26b being connected to the second transmit/receive circuit 28b, the split port 26c being connected to the third transmit/receive circuit 28c, and the split port 26d being connected to the fourth transmit/receive circuit 28d.

Each transmit/receive circuit 28 has a separate transmit chain and a receive chain that are selectively connected to the phase shifter 30 with the single pole, double throw switch 32. The transmit chains of each transmit/receive circuit 28 includes the variable gain power amplifier 34 and the power amplifier 36, and while the receive chains each includes the variable gain low noise amplifier 38 and the low noise amplifier 40. The transmit chain and the receive chains are independently and selectively connectible to the directional coupler 52 via the separate single pole, single throw switches 56, 58. As the details of the transmit/receive circuits 28 have been discussed above, for the sake of brevity, those details will not be repeated.

The bi-directional couplers utilized in the embodiment shown in FIG. 4 each include the input port 60, the transmitted port 62, the first coupled port 64, and the second coupled port 68. The input ports 60 are connected to the transmit/receive circuits 28, and the transmitted ports 62 are connected to the antenna elements 14. In further detail, the first transmit/receive circuit 28a is connected to the input port 60a of the first bi-directional coupler 52a′, with its transmitted port 62a being connected to the first antenna element 14a. Likewise, the second transmit/receive circuit 28b is connected to the input port 60b of the second bi-directional coupler 52b′, with its transmitted port 62b being connected to the second antenna element 14b. The third transmit/receive circuit 28c is connected to the input port 60c of the third bi-directional coupler 52c′, with its transmitted port 62c connected to the third antenna element 14c. Lastly, the fourth transmit/receive circuit 28d is connected to the input port 60d of the fourth bi-directional coupler 52d′, and the transmitted port 62d thereof is connected to the fourth antenna element 14d.

Rather than connecting the first coupled ports 64a-64d to one RF calibration and test circuit switch 66 and connecting the second coupled ports 68a-68d to another RF calibration and test circuit switch 66, the first and second coupled ports 64, 68 are selectively connected to one RF calibration and test circuit switch 66. This selective connection of the coupled ports may be achieved with separate single pole, single throw switches 70.

For the first directional coupler 52a, the first coupled port 64a thereof may be connected to a first single pole, single throw switch 70a-1, while the second coupled port 68b may be connected to a second single pole, single throw switch 70a-2. During transmit mode operations, the second single pole, single throw switch 70a-2 is toggled on to connect the second coupled port 68a to the RF calibration and test circuit switch 66, while the first single pole, single throw switch 70a-1 is toggled off to disconnect the first coupled port 64a. During receive mode operations, the opposite is true, with the second single pole, single throw switch 70a-2 being toggled off to disconnect the second coupled port 68a from the RF calibration and test circuit switch 66 and the first single pole, single throw switch 70a-2 being toggled on to connect the first coupled port 64a to the RF calibration and test circuit switch 66. Both of the first and second single pole, single throw switches 70a are understood to be connected to the first throw terminal 69a of the RF calibration and test circuit switch 66.

For the second directional coupler 52b, the first coupled port 64b thereof may be connected to a first single pole, single throw switch 70b-1, while the second coupled port 68b may be connected to a second single pole, single throw switch 70b-2. The toggling of the first and second single pole, single throw switches 70b-1 and 70b-2 are understood to be the same as for those associated with the first directional coupler 52a as described above. Both of the first and second single pole, single throw switches 70b are connected to the second throw terminal 69b of the RF calibration and test circuit switch 66.

In relation to the third directional coupler 52c, the first coupled port 64c thereof may be connected to a first single pole, single throw switch 70c-1, while the second coupled port 68c may be connected to a second single pole, single throw switch 70c-2. Again, the toggling of the first and second single pole, single throw switches 70c-1 and 70c-2 are understood to be the same as for those associated with the first directional coupler 52a and the second directional coupler 52b as described above. Both of the first and second single pole, single throw switches 70c are connected to the third throw terminal 69c of the RF calibration and test circuit switch 66.

Referring now to the fourth directional coupler 52d, the first coupled port 64d thereof may be connected to a first single pole, single throw switch 70d-1, and the second coupled port 68d may be connected to a second single pole, single throw switch 70d-2. The toggling of the first and second single pole, single throw switches 70d-1 and 70d-2 are understood to be the same as for those associated with the first directional coupler 52a, the second directional coupler 52b, and the third directional coupler 52c as described above. Both of the first and second single pole, single throw switches 70d are connected to the fourth throw terminal 69d of the RF calibration and test circuit switch 66.

The desired one of the transmit/receive circuits 28 to be tested may be selected via the RF calibration and test circuit switch 66, which connects the pole terminal thereof to one of the throw terminals 69a-69d. The toggling of the switches between testing the transmit chain circuitry and the receive chain circuitry is understood to involve the single pole, double throw switch 32, the single pole, single throw switches 56, 58, and the single pole, single throw switches 70-1, 70-2 that are operated in a coordinated manner to selectively connect the transmit chain or the receive chain to the RF calibration and test circuit switch 66.

The embodiment of the phased array beamformer circuit 10 shown in FIG. 4 is understood to include each of the foregoing components of the antenna interface circuits 18 for the 5G mmWave low band, vertical polarization feed, the high band, horizontal polarization feed, and the high band, vertical polarization feed. The schematic diagram shows the second RF input/output port 20b for the low band vertical polarization feed, the third RF input/output port 20c for the high band horizontal polarization feed, and the fourth RF input/output port 20d for the high band vertical polarization feed, though without the additional details of the respective antenna interface circuits 18 because they have been omitted for the sake of brevity. The circuit 10 is understood to include the RF calibration and test circuit switch 66b for the low band vertical polarization feed, the RF calibration and test circuit switch 66c for the high band horizontal polarization feed, and the RF calibration and test circuit switches 66d for the high band vertical polarization feed, each of which are understood to be connected to respective directional couplers 52.

The embodiment of the phased array beamformer circuit 10 shown in FIG. 4 is envisioned to likewise have the same capability of testing the entirety of the transmit and receive chains of each of the transmit/receive circuits for gain, phase shift, power, and linearity without the need for OTA test chambers while real antenna elements 14 are in place, as discussed in more detail above in relation to the embodiments shown in FIGS. 1, 2, and 3. The elimination of the second RF calibration and test circuit switch 66 is contemplated to reduce the semiconductor die area. This embodiment contemplates the measurement of non-real time antenna mismatch characteristics in both the transmit mode and the receive mode during production, as well as in the transmit mode in an actual use setting by toggling specific single pole, single throw switches. Moreover, separate polarizations and separate frequency bands may be tested simultaneously at the board level, while the real antenna impedance is presented at the output of the power amplifier and the input to the low noise amplifier.

Each of the switches referenced herein, and in particular, those cooperating with the directional coupler 52, are understood to be operating at low power, e.g., less than or equal to −10 dBm. The additional circuit components utilized to implement the RF calibration and test circuit 48 are understood not to measurably consume additional current.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

1. A phased array beamformer circuit connectible to an array of antenna elements, the circuit comprising:
one or more of radio frequency (RF) input/output ports;
one or more of splitter-combiners each including a combined port connected to a respective one of the one or more RF input/output ports, and one or more split ports;
one or more transmit/receive chains each connected to a respective one of the split ports of the splitter-combiners and to a respective one of the antenna elements of the array; and
an RF calibration and test circuit with one or more calibration and test ports each corresponding to given ones of the antenna elements of the array and selectively connectible to the transmit/receive chain to which the given ones of the antenna elements is associated.

2. The circuit of claim 1, wherein each of the transmit/receive chains includes:
a phase shifter with a first port connected to one of the split ports of a given one of the splitter-combiners, and a second port;
a transmission amplification segment;
a reception amplification segment; and
a first switch selectively connecting the transmission amplification segment and the reception amplification segment to the second port of the phase shifter;
a second switch selectively connecting the transmission amplification segment and the reception amplification segment to the respective one of the antenna elements of the array.

3. The circuit of claim 2, wherein the transmission amplification segment includes a power amplifier and a variable gain power amplifier connected in series.

4. The circuit of claim 2, wherein the reception amplification segment includes a low noise amplifier and a variable low noise amplifier connected in series.

5. The circuit of claim 1, wherein each of the antenna elements is horizontally polarized and vertically polarized, with a first one of the splitter combiners and one of the transmit/receive chains connected thereto are connected to a horizontal polarization antenna feed of a given one of the antenna elements, and a second one of the splitter combiners and another one of the transmit/receive chains connected thereto are connected to a vertical polarization antenna feed of the given one of the antenna elements.

6. The circuit of claim 5, wherein the first one of the splitter combiners and the transmit/receive chains connected thereto, and the second one of the splitter combiners and the transmit/receive chains connected thereto are configured for 5G millimeter wave high band operation.

7. The circuit of claim 5, wherein the first one of the splitter combiners and the transmit/receive chains connected thereto, and the second one of the splitter combiners and the transmit/receive chains connected thereto are configured for 5G millimeter wave low band operation.

8. A radio frequency (RF) integrated circuit connectible to an array of antenna elements, the circuit comprising:
an RF input/output port specific to an operating band and an antenna polarization;
a splitter-combiner including a combined port connected to the RF input/output port, and one or more split ports;
one or more transmit/receive chains each connected to a respective one of the split ports of the splitter-combiner and including a transmit segment and a receive segment;
one or more directional couplers each associated with a corresponding one of the transmit/receive chains and including an input port selectively connectible to the transmit segment and the receive segment thereof, a transmitted port connected to a respective one of the antenna elements of the array, and a first coupled port; and
a first RF calibration and test circuit switch selectively connecting an RF calibration and test port to the first coupled port of a given one of the one or more directional couplers.

9. The RF integrated circuit of claim 8, wherein the directional couplers are uni-directional.

10. The RF integrated circuit of claim 8, wherein each of the directional couplers has a high coupling coefficient with minimal insertion loss.

11. The RF integrated circuit of claim 10, wherein each of the directional couplers has a coupling coefficient greater than 20 dB, and an insertion loss of less than 0.3 dB.

12. The RF integrated circuit of claim 8, wherein each of the transmit/receive chains includes:
a phase shifter with a first port connected to one of the split ports of the splitter-combiners, and a second port; and
a first switch selectively connecting the transmit segment and the receive segment to the second port of the phase shifter.

13. The RF integrated circuit of claim 12, wherein each of the transmit/receive chains includes:
a first single pole, single throw switch selectively connecting the transmit segment to the input port of the directional coupler; and
a second single pole, single throw switch selectively connecting the receive segment to the input port of the directional coupler.

14. The RF integrated circuit of claim 12, wherein the operating band is selected from a group consisting of: a 5G millimeter wave low band, and a 5G millimeter wave high band.

15. The RF integrated circuit of claim 8 wherein the directional couplers are bi-directional, and each further includes a second coupled port.

16. The RF integrated circuit of claim 15, further comprising:
a second RF calibration and test circuit switch selectively connecting a RF calibration and test port to the second coupled port of a given one of the one or more directional couplers.

17. The RF integrated circuit of claim 15, further comprising:
a set of first coupler single pole, single throw switches each selectively connecting the first coupled port of a given one of the directional couplers to the first RF calibration and test circuit switch; and
a set of second coupler single pole, single throw switches each selectively connecting the second coupled port of the given one of the directional couplers to the first RF calibration and test circuit switch.

18. The RF integrated circuit of claim 17, wherein the first RF calibration and test circuit switch is a single pole, multiple throw switch, with each grouped pair of first coupler single pole, single throw switches and second coupler single pole, single throw switches for the given one of the directional couplers is connected to a respective throw terminal of the RF calibration and test circuit switch.

19. A millimeter wave radio frequency (RF) integrated circuit comprising:
an antenna array defined by a plurality of cross-polarized antenna elements each including a horizontal feed and a vertical feed;
one or more of RF input/output ports;
a plurality of array antenna interface circuits connected to a given one of the RF input/output ports and respective ones of the horizontal feed and the vertical feed of each of the cross-polarized antenna elements; and
an RF calibration and test circuit with calibration and test ports corresponding to each of the cross-polarized antenna elements and selectively connectible to the antenna array interface circuits.

20. The RF integrated circuit of claim 19, wherein each of the array antenna interface circuits includes:
a splitter combiner connected to a given one of the RF input/output ports;
one or more transmit/receive chains connected to the splitter combiner and each transmit/receive chain being associated with a given one of the cross-polarized antenna elements; and
one or more directional couplers connected to a corresponding one of the transmit/receive chains and to the given one of the cross-polarized antenna elements.
